(19) United States
(12) Patent Application Publication
(10) Pub. No.: US 2002/0077951 A1
(43) Pub. Date: Jun. 20, 2002

(54) Method, system, computer, and computer readable medium for identifying a preferred defined contribution plan

(76) Inventors: David Gilbert, Emerald Hills, CA (US); Vishwanath Shastry, San Francisco, CA (US); David Huntley, Townson, MD (US); Joseph Valleta, Townson, MD (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 09/837,650

(22) Filed: Apr. 18, 2001

Related U.S. Application Data
(60) Provisional application No. 60/197,992, filed on Apr. 18, 2000.

(51) Int. Cl. G06F 17/60

(52) U.S. Cl. 705/36

(57) ABSTRACT

A method, system, computer and computer readable medium is provided for identifying a defined contribution plan, such as a 401(k) plan. In an embodiment of the present invention, a plurality of defined contribution plan preference values is transferred from a broker processing device to a central processing device. A broker obtains the preference values from a plan sponsor. A plan provider provides a plurality of defined contribution plan to the central processing device. The plurality of defined contribution plans that have respective performance categories are scored by the central processing device to obtain respective performance category scores. The plurality of defined contribution plans are ordered by the plurality of performance categories scores and assigned respective rank values. A preferred defined contribution plan is then transferred to the broker processing device in response to the plurality of preference values and rank values.

### CLAIM OF PRIORITY

The present application claims priority to U.S. Provisional Patent Application Serial No. 60/197,992, entitled, “Method and System for Research, Analysis and Electronic Prioritization of Defined Contribution Benefit Plan Investments,” filed on Apr. 18, 2000.

### FIELD OF THE INVENTION

The present invention relates generally to electronic financial analysis and advisory systems, and in particular, identifying a defined contribution plan.

### BACKGROUND OF THE INVENTION

A defined contribution plan is a company retirement plan, such as a 401(k) or 403(b) plan, in which an employee, by election, chooses to defer some amount of their compensation, up to a set annual limit, into the plan. The employee bears the investment risk and the employee, employer or both may make contributions. A 401(k) plan is a defined contribution plan offered by a corporation to its employees that, pursuant to Internal Revenue Code, as amended 1986, allows employees to set aside tax-deferred income for retirement purposes. A 403(b) plan is a retirement plan similar to a 401(k) plan that is offered by nonprofit organizations, such as universities and charities.

An employer who makes a defined contribution plan available to its employees is typically called a plan sponsor. Employees participating in the defined contribution plan are often called plan participants. A financial service firm that provides investment vehicles for the defined contribution plan and handles the related administration is typically known as a plan provider or vendor. A plan sponsor often uses an intermediary, or broker, to select a plan provider. Depending on the type of plan, brokers may be insurance brokers or securities brokers. Insurance brokers operate with state insurance licenses. The National Association of Securities Dealers assigns a unique identification number to licensed securities brokers.

For brokers and plan sponsors, the process of identifying a plan provider having a preferred defined contribution plan in this decentralized marketplace is arduous and expenses. There are approximately 360,000 401(k) plans, 314,000 brokers, and 3000 financial service firms offering asset management. Over approximately 87% of 401(k) plans are for small companies, and of those companies, more than approximately 80% use brokers to assist in the selection of a plan provider.

Each year, more than approximately 250,000 plans are put out for bid each from plan sponsors who are either creating their first plan or changing plan providers for an existing plan. These plan sponsors typically use an average of three brokers who may create as many as 10 requests for proposals (“RFPs”) to potential plan providers. Typically, a plan provider then spends an amount greater than approximately $2000 in response to each RFP. A typical RFP process takes approximately three months from start to finish.

Plan providers pay substantial costs to acquire new plans. Often it takes years before revenue recovers cost associated with the acquired the new plan. For example, a plan provider may receive annual fees of 1.5% of assets on small plans; yet face initial costs, such as broker fees, customer acquisition and customer service fees, of greater than 2%.

Therefore, it is desirable to provide a centralized and cost effective method, system, computer and computer readable medium for selecting a preferred defined contribution plan.

Brokers are interested in reducing costs and reducing research and analysis time in obtaining a preferred defined contribution plan for a plan sponsor. Further, brokers are interested in obtaining accurate information on qualified plans that meet plan sponsor's preferences as well as obtaining additional plan sponsors as customers.

Similarly, plan providers are interested in reducing costs and contracting with a greater number of plan sponsors. By reducing a RFP process time, plan providers are able to obtain a larger number of contracts with plan sponsors.

Plan sponsors desire a large pool of plan providers to select from in order to obtain a greater value in their defined contribution plan by increasing the available choices that meet their plan characteristics and preferences. Plan sponsors, as with brokers and plan providers, also desire a reduction in the RFP process time and thus faster implementation of their defined contribution plan for their plan participants.

### SUMMARY OF THE INVENTION

A method for identifying a preferred defined contribution plan is provided. The method includes the steps of transferring from a broker processing device to a central processing device a plurality of preference values associated with a respective plurality of performance categories. The central processing device stores a plurality of defined contribution plans. A first defined contribution plan includes a plurality performance categories and a respective plurality of performance category scores. The central processing device orders the plurality of defined contribution plans by the plurality of performance category scores. The central processing device assigns a plurality of rank values to the respective plurality of defined contribution plans corresponding to the respective plurality of performance category scores. The central processing device transfers a preferred defined contribution plan to the broker processing device in response to the plurality of preference values and plurality of rank values.

According to another embodiment of the present invention, the defined contribution plan is a 401(k) plan.

According to another embodiment of the present invention, the performance categories are selected from a group consisting of a) communication between the plan sponsor and plan participants, b) investment advice offered to plan participants, c) extent or ability to increase participation at a later date, d) flexibility in using multi-fund family offerings, e) performance of investments, f) ability of self-directed accounts, g) cost to the plan sponsor, h) cost to the plan participants, i) amount of internal administration provided, j) accuracy and timeliness of the administration, k) existence of a local service contact, and l) ability to handle trustee and 404(c) concerns.

According to another embodiment of the present invention, the transferring step includes the step of using a graphic user interface to input the plurality of preference values.

According to another embodiment of the present invention, the method further comprises a broker entering plan characteristics that describe the employee demographics and size of plan. The plan characteristics are selected from a group consisting of a) number of plan participants, b) plan size measured by assets, and c) cash flow.

According to another embodiment of the present invention, the first rank value in the plurality of rank values is a number between 1 and 5.

According to another embodiment of the present invention, the plan sponsor provides defined contribution plan characteristics and preferences to a broker.

According to another embodiment of the present invention, the transferring step includes multiplying a first rank value in the plurality of rank values by a first preference value in the plurality of preference values to obtain a first plan category value.

According to yet another embodiment of the present invention, the transferring step includes multiplying a second rank value in the plurality of rank values by second preference value in the plurality of preference values to obtain a second plan category value. The first plan category value and the second plan category value are summed to select the preferred defined contribution plan.

According to still another embodiment of the present invention, the assigning step includes assigning a rank value to a cost to company category in response to a Grid Matrix Analysis.

According to another embodiment of the present invention, a computer (or a network of computers) for identifying a preferred defined contribution plan is provided. The computer(s) comprises a storage device coupled to a processor. The storage device stores a program for controlling the processor that operates with the program to receive a plurality of preference values. A plurality of defined contribution plans are scored by the computer. A first defined contribution plan includes a plurality of performance categories and a respective plurality of performance category scores. A plurality of defined contribution plans are ordered by the plurality of performance category scores. A plurality of rank values are assigned to the respective plurality of defined contribution plans corresponding to the respective plurality of performance category scores. A preferred defined contribution plan is selected in response to the plurality of preference values and plurality of rank values.

According to another embodiment of the present invention, the storage device stores a database containing the plurality of defined contribution plans and the respective plurality of performance category scores. The storage device also stores a plurality of broker identification numbers.

According to another embodiment of the present invention, an article of manufacture including a computer readable medium is provided. The computer readable medium comprises a first software program for receiving a plurality of preference values associated with respective performance categories. A second software program scores a plurality of defined contribution plans. A third software program orders the plurality of defined contribution plans by a respective plurality of performance category scores. A fourth software program assigns a plurality of rank values to the respective plurality of defined contribution plans corresponding to the respective plurality of performance category scores. A fifth software program provides a preferred defined contribution plan in response to the plurality of preference values and the plurality of rank values. The software programs and persistent storage may be physically present on multiple computers within a network.

Other aspects and advantages of the present invention can be seen upon review of the figures, the detailed description, and the claims that follow.

### BRIEF DESCRIPTION OF THE FIGURES

FIG. 1 illustrates a system for identifying a preferred defined contribution plan according to an embodiment of the present invention.

FIG. 2 illustrates a data flow diagram according to an embodiment of the present invention.

FIG. 3 illustrates a user interface for inputting plan category preference values according to an embodiment of the present invention.

FIG. 4 illustrates a user interface for providing a list of potential defined contribution plans having a plan sponsor's characteristics and preferences according to an embodiment of the present invention.

FIG. 5 illustrates the amount of time for identifying a preferred defined contribution plan according to an embodiment of the present invention.

FIG. 6 illustrates a method for selecting a preferred defined contribution plan based on a plan sponsor's preferences according to an embodiment of the present invention.

### DETAILED DESCRIPTION

The following description and claims relate to a system that allows a broker to research, analyze and select a defined contribution plan, such as a 401(k) plan.

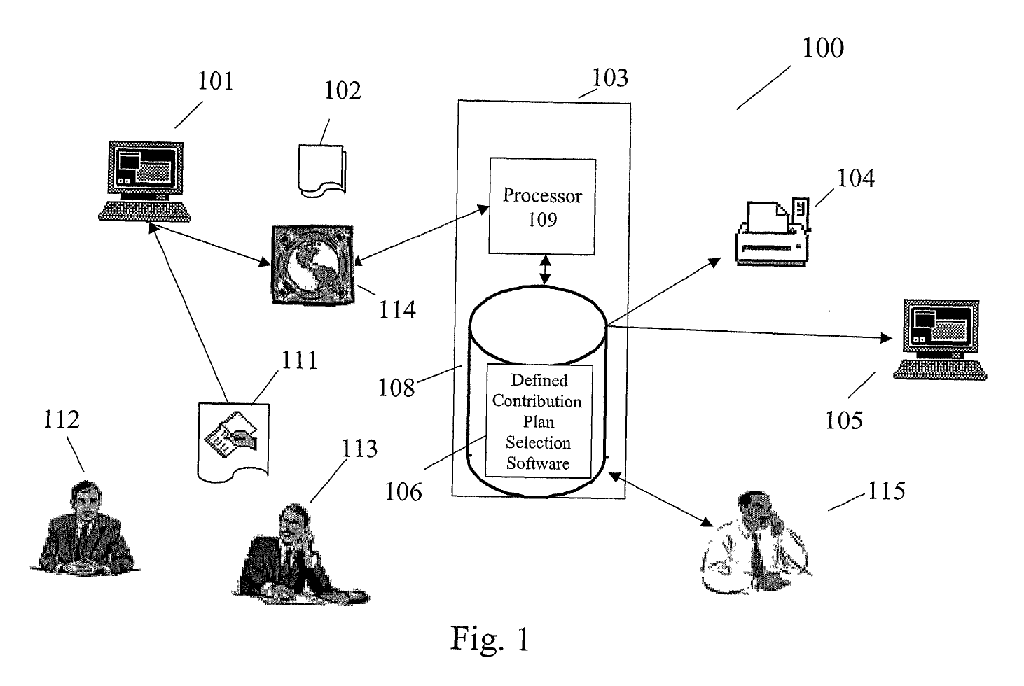

FIG. 1 illustrates a system 100 including a broker processing device 101, central processing device 103 and local central processing device 105. According to an embodiment of the present invention, processing devices shown in FIG. 1 are, singly or in combination, a mainframe computer, a desktop computer, a hand-held computer, a personal digital assistant, a telephone, a pager, an information appliance, or and equivalent thereof. In an embodiment of the present invention, Internet 114 transfers information 102, such as plan sponsor characteristics and preferences, from processing device 101 to processing device 103. Likewise, Internet 114 transfers information output from processing device 103 to processing device 101. Processing device 105 and printer 104 are used to access and print out relevant information from processing device 103 in an embodiment of the present invention.

In an alternate embodiment of the present invention, system 100 is an intranet or includes a local area network.

In an embodiment of the present invention, processing device 103 includes a computer or server having processor 109 and an article of manufacture 108, such as a computer readable medium. In an alternate embodiment of the present invention, processing device 103 may have multiple networked distributed processors. Likewise, computer readable medium 108 may have multiple computer readable media storing defined contribution plan selection software 106. In an embodiment of the present invention, defined contribution plan selection software 106 is stored in a magnetic hard disk, an optical disk, a floppy disk, CD-ROM (Compact Disk Read-Only Memory), RAM (Random Access Memory), ROM (Read-Only Memory), or other readable or writeable data storage technologies, singly or in combination. In alternate embodiments of the present invention, portions of defined contribution plan selection software 106 are stored in article of manufacture 108. In still another embodiment of the present invention, software 106 is downloaded over Internet 114.

In an embodiment of present invention, processing device 101 includes a graphic user interface and web browser for accessing processing device 103.

In an embodiment of the present invention, plan sponsor 112 provides broker 113 with characteristics 111 of the plan sponsor's 112 present or new defined contribution plan. For example, plan sponsor 112 will identify the number of plan participants, plan size, cash flow and existing plan assets. Further, plan sponsor 112 will identify multiple preference values corresponding to a plurality of respective performance categories of a desired defined contribution plan. In an embodiment of the present invention, the performance categories include a) communication between a plan sponsor and plan participants, b) investment advice offered to plan participants, c) extent or ability to increase participation at a later date, d) flexibility in using multi-fund family offerings, e) performance of investments, f) ability to self-direct an account, g) cost to plan sponsor, h) cost to plan participants, i) amount of internal administration necessary or provided, j) accuracy and timeliness of the administration, k) existence of a local service contact and m) ability to handle trustee and 404(c) concerns.

In an embodiment of the present invention, plan provider 115 provides processing device 103 with a single or multiple types of defined contribution plans. Plan provider 115 provides the defined contribution plans by way of Internet 114 in an embodiment of the present invention.

In an embodiment of present invention, a preference value associated with a performance category of a defined contribution plan will be a number between 1 and 5. In an alternate embodiment of the present invention, plan sponsor 112 will not use broker 113 and will enter all relevant information, such as plan characteristics and preferences, into processing device 101.

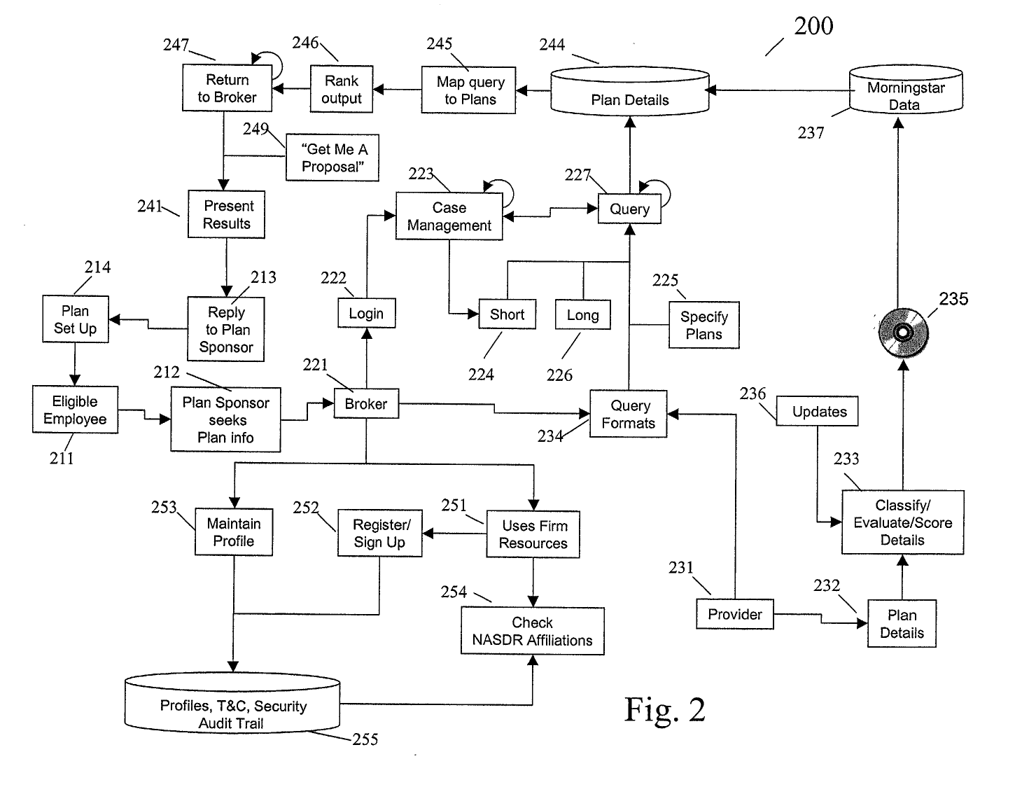

As one who is skilled in the art would appreciate, FIG. 2 illustrates a data flow diagram having logic boxes for representing individuals, information, devices or process steps for performing specific functions according to an embodiment of the present invention. More or fewer logic boxes or steps are used in alternate embodiments. In an embodiment of the present invention, a logic box or step may represent a software program, a software object, a software function, a software subroutine, a software method, a software instance, a code fragment, a hardware operation or user operation, singly or in combination. FIG. 2 illustrates a flow of data for system 100 illustrated in FIG. 1 according to an embodiment of the present invention.

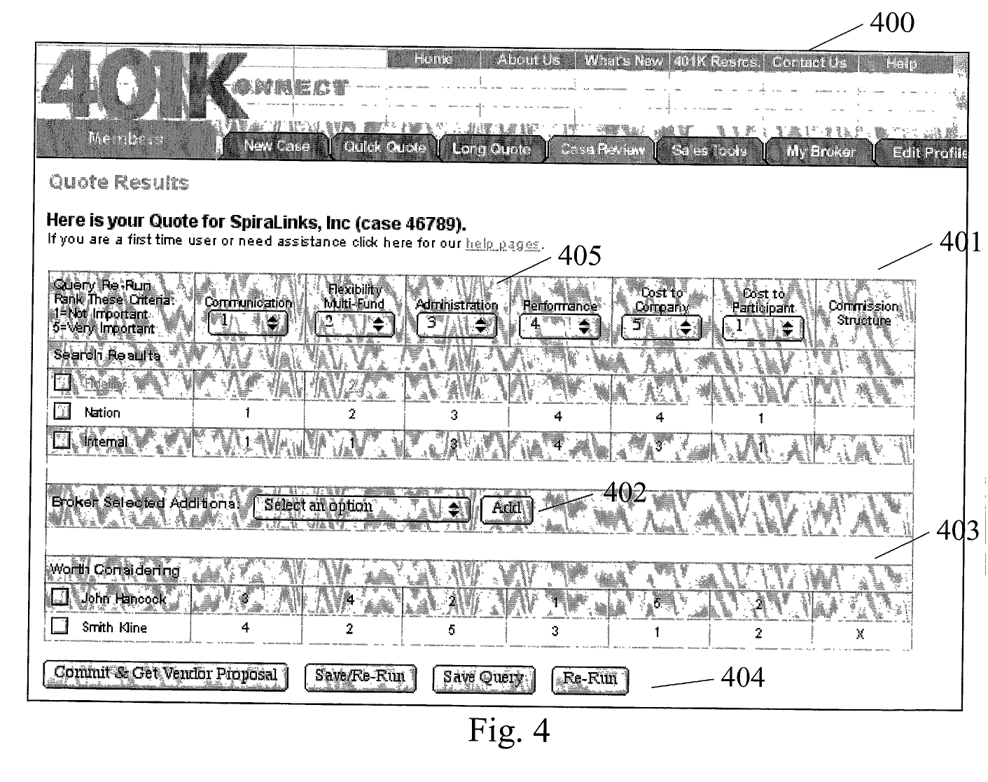

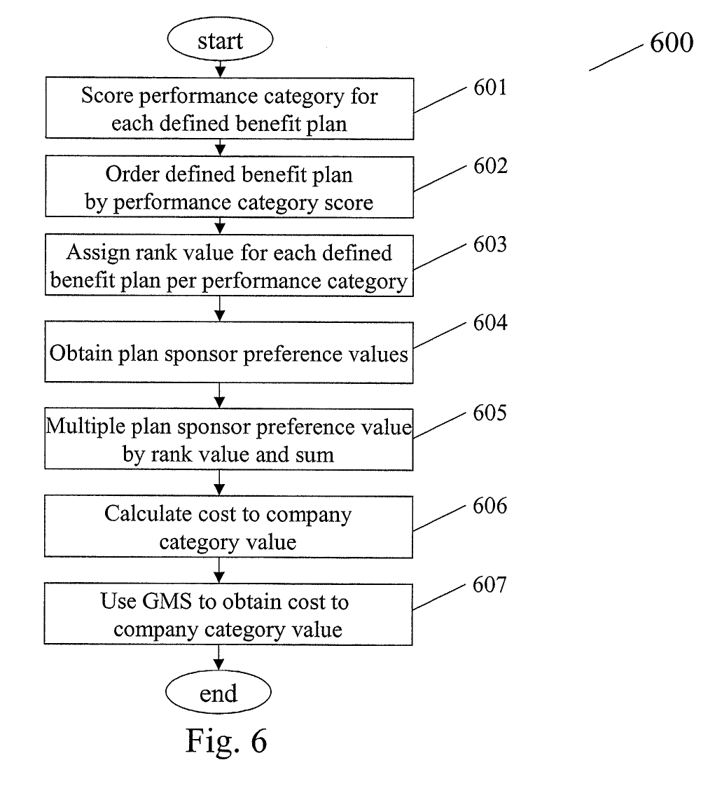

A plan sponsor 112 obtains the number of eligible employees as represented by block 211. Plan sponsor 112, represented by logic block 212, provides broker 113, represented by logic block 221, plan characteristics and category preference values. Ultimately, system 100 provides plan sponsor 112 with results showed as logic block 241. The reply to plan sponsor 213 may include a number of defined contribution plans provided by multiple plan providers as illustrated in FIGS. 4 and 6. Plan sponsor 112 then may select the preferred defined contribution plan and provide the plan to the employees as shown by logic block 214.

Licensed securities brokers are typically members of financial firms and can be identified by their personal Central Registration Depository (“CSD”) numbers. Broker 113 has access to firm resources as illustrated by logic block 251. Broker 113 registers with processing device 103 as shown by logic block 252. Broker 113 maintains a broker profile that tracks broker's association with firms as shown by logic block 253. Broker profiles along with other information are stored in persistent storage 255. In an embodiment of the present invention, storage 255 is computer readable medium 108. Firm IDs and CRD numbers for both firms and brokers are obtained by a NASD web site, as shown by logic block 254. For licensed insurance brokers, no centralized process exists.

A broker 113 logs into processing device 103, as shown by logic block 222, using broker processing device 101. In an embodiment of present invention, broker 113 uses a user ID and password that may be personalized. Existing and new plan sponsors are provided by a user interface as illustrated by logic block 223. Further, broker 113 may access plan sponsor plans, proposals and history.

A broker 113 may query, as shown by logic block 227, processing device 103, and in particular use defined contribution plan selection software 106, for a match between the plan sponsor's characteristic/preferences and a plan provider plan. A short or long quote may be obtained depending upon the number of questions broker 113 answers, as illustrated by logic block 224 and 226, respectively.

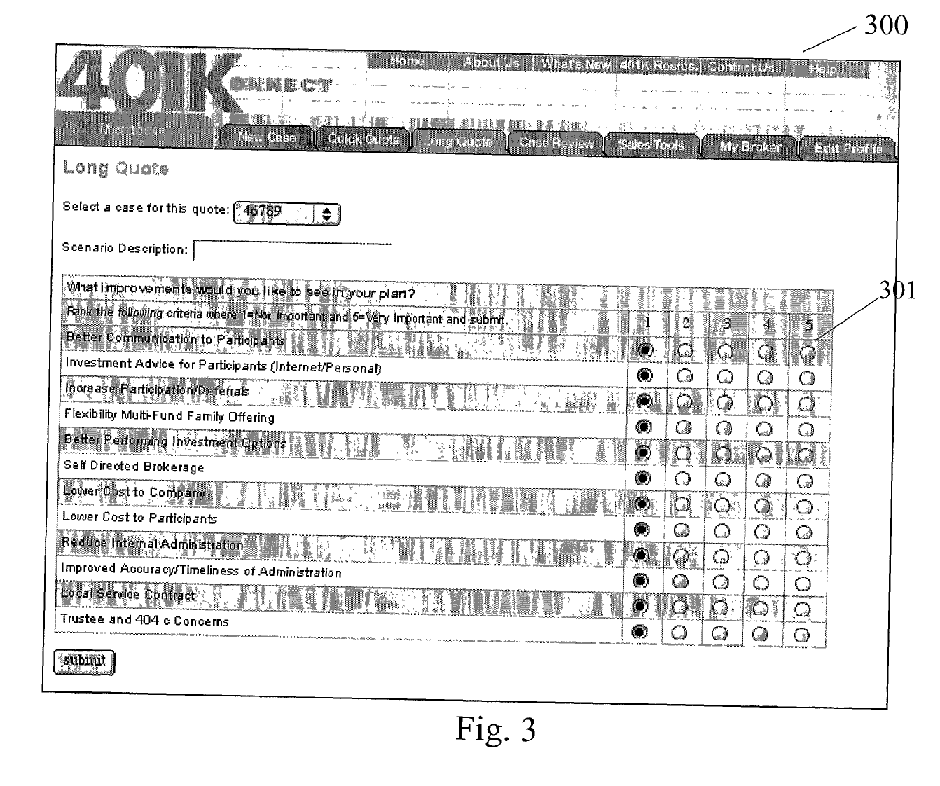

FIG. 3 illustrates user interface 300 provided by processing device 103 to broker 113 in order to input plan sponsor 112 preferences by way of answering a plurality of questions. In an embodiment, user interface 300 is a web page. For example, broker 113 may click circle 301 to indicate that plan sponsor 112 prefers better communication between a plan provider and plan participants.

Broker 113 may also specify a particular defined contribution plan or sponsor to be included in a selection or match process, as shown by logic block 225.

FIG. 4, and logic block 247 in FIG. 2, illustrate a user interface provided to broker 113 including an identified preferred defined contribution plan. Window 401 provides three plan providers (fidelity, nation and internal) having defined contribution plans that closely match plan sponsor 112's characteristics and preferences. In an embodiment of the present invention, these plan providers were selected by software 106 performing method 600 illustrated in FIG. 6. Row 405, illustrated in FIG. 4, shows plan sponsor preference values associated with performance categories. For example, a plan sponsor 112 has given a 1 value for the communication category. In an embodiment of present invention, a 5 value corresponds to highly important while a 0 value corresponds to not important. Window 402 illustrates the broker selected plan in logic block 225. Window 403 illustrates other potential plan sponsors. Buttons 404 allow for other broker actions, such as obtaining a plan provider proposal, re-run or saving a query.

In an alternate embodiment, comparative reports in a Hyper Text Markup Language (“HTML”) or excel format compares features among plans provided in logic block 247.

In logic block 249, a broker decides to obtain a proposal.

In an embodiment of the present invention, plan sponsor preferences and characteristics in a query, as illustrated by logic block 227, are used with a plurality of defined contribution plans with their scores stored in storage 244 and logic blocks 245 and 246 to provide broker 113 with a preferred defined contribution plan. In an embodiment of the present invention, storage 244 is computer readable medium 108. In an embodiment of the present invention, logic blocks 245 and 246 identify a preferred defined contribution plan using method 600 illustrated in FIG. 6 and described in detail below. Logic blocks 246 and 245 represent logical steps where multiple plan sponsor preference values are multiplied against plan scores and summed across performance categories to obtain total scores, which then allows ranking of plan providers from high to low.

In an embodiment of the present invention, logic block 245 includes a filter or mapping so that only plan providers having plans meeting plan sponsor characteristics are provided in logic block 247. For example, a broker could request only plan providers that have plans in which the plan assets are equal or greater than a plan provider minimum plan size by assets.

A plan provider 112, shown as logic block 231, provides defined contribution plan details, shown as logic block 232, to central processing device 103. Central processing device 103 classifies, evaluates and scores plan details as illustrated by logic block 233 where data are reviewed for accuracy and score values are obtained as described below.

In an embodiment of the present invention, plan details are stored on CD-ROM 235. Plan providers provide updates, as illustrated by logic block 236, to logic block 233. In an embodiment of present invention, plan details are in a database stored on computer readable medium 108. In an embodiment of the present invention, Morningstar data will be provided to CD-ROM 235 and plan storage 244.

FIG. 6 illustrates a method 600 for identifying a preferred defined contribution plan for a plan sponsor in response to plan characteristics and plan sponsor preference values. In an embodiment, method 600 is performed by defined contribution plan selection software 106 illustrated in FIG. 1. In an embodiment of the present invention, a logic box or step illustrated in FIG. 6 may represent a software component, such as a software program, a software object, a software function, a software subroutine, a software method, a software instance, a code fragment, singly or in combination. In an alternate embodiment of the present invention, a logic box or step may be a hardware operation or user operation, singly or in combination.

Each defined contribution plan stored in plan detail storage 244 is scored as illustrated by logic block 601. A performance category score is calculated for each performance category, as described below, for each defined contribution plan. For each category, each defined contribution plan starts with a baseline score value. Based on a plan provider's responses to a series of survey questions to obtain plan performance, points are either added or subtracted from the baseline score value to provide a per-plan per-category score. In an embodiment of the present invention, there are several questions in each category that impact the baseline score, and each question may be weighted differently from another such that some questions might add plus or minus two (2) points to the baseline score and other questions might add plus or minus one (1) point. These questions may be similar to those illustrated in FIG. 3.

In logic block 602, defined contribution plans are numerically ordered based on score values of performance categories in logic block 601. In an embodiment of the present invention, defined contribution plans are separated in quintiles according to the score values of respective performance catagories. Thus, the result is that in each performance category the top twenty (20) percent of defined contributions plans form one quintile, the next twenty (20) percent another quintile and so forth.

In logic block 603, each quintile for each performance category is assigned a non-fractional numerical value between one (1) and five (5) based on the underlying plans'performances. The top quintile, representing the top twenty percent (20%) of a category is assigned a score of five (5). The bottom quintile, representing the bottom twenty percent (20%) for a given category is assigned a score of one (1). The second to last quintile is scored a two (2), the middle quintile a score of three (3), and the second best quintile a score of four (4).

In logic block 604, plan sponsor preference values are obtained as illustrated by logic block 224 and 226 in FIG. 2 and user interface 300 illustrated in FIG. 3. In an alternate embodiment, preference values are obtained from computer readable medium 108.

In logic block 605, plan sponsor preference values are multiplied in each category by each defined contribution plan's quintile rank value. For example Table A illustrates comparing two plans, Plan X and Plan Y, across three categories, Category 1, Category 2, and Category 3. The numerical values in Table A are used are used to explain an embodiment of the present invention.

TABLE A

| | Plan | | | | |
|---|---|---|---|---|---|
| | sponsor | Plan X | | Plan Y | |
| | Preference | rank | Plan X | rank | Plan Y |
| Performance | values | value | Value | value | Value |
| Category | (n) | (m) | (= n * m) | (p) | (= n * p) |
| 1 | 3 | 4 | 12 | 2 | 6 |
| 2 | 5 | 2 | 10 | 4 | 20 |
| 3 | 2 | 3 | 6 | 3 | 6 |

Each defined contribution plan's value per category is added into a sum total. In the above example, Plan X would return a total score of 28 points and Plan Y would return a total score of 32 points. The sum is then organized into numerical order and the highest scoring defined contribution plans are returned to broker 113 for review, as illustrated in FIG. 4, having been identified as the preferred defined contribution plans according to plan sponsor preference values.

The present method applies to all of the performance categories, described above, except for the cost to company performance category or the amount a plan provider 115 would reasonably charge a plan sponsor 112 for the service offering (e.g. defined contribution plan). The “Cost to Company” is a variable number based on two primary criteria: a) the number of plan participants and b) the total value of assets held in the defined contribution plan.

In an embodiment of the present invention, the cost to company performance category is evaluated in two ways. First, as illustrated by logic block 606, the cost to company value is mathematically calculated on-the-fly in real time. The cost to company value is then ranked into quintiles, as above. Once in quintiles, the selection process continues as described above.

TABLE B

| | | | | |
|---|---|---|---|---|
| <100 Employees | 2 | 3 | 2 | 1 |
| <50 Employees | 4 | 4 | 3 | 4 |
| <25 Employees | 3 | 5 | 5 | 3 |
| <10 Employees | 1 | 1 | 4 | 3 |
| | <$25k | <$75k | <$150k | <$200k |

In logic block 607, a cost to company performance value is calculated according to a predetermined, fixed Grid Matrix Analysis (GMA). In GMA, a cost to company performance value is determined from a data grid established per each plan, as illustrated in Table B. One axis in Table B, the “X axis,” represents the assets in the defined contribution plan. The other axis in Table B, the “Y Axis” represents the number of plan participates. The numerical values in Table B are used to illustrate embodiments of the present invention.

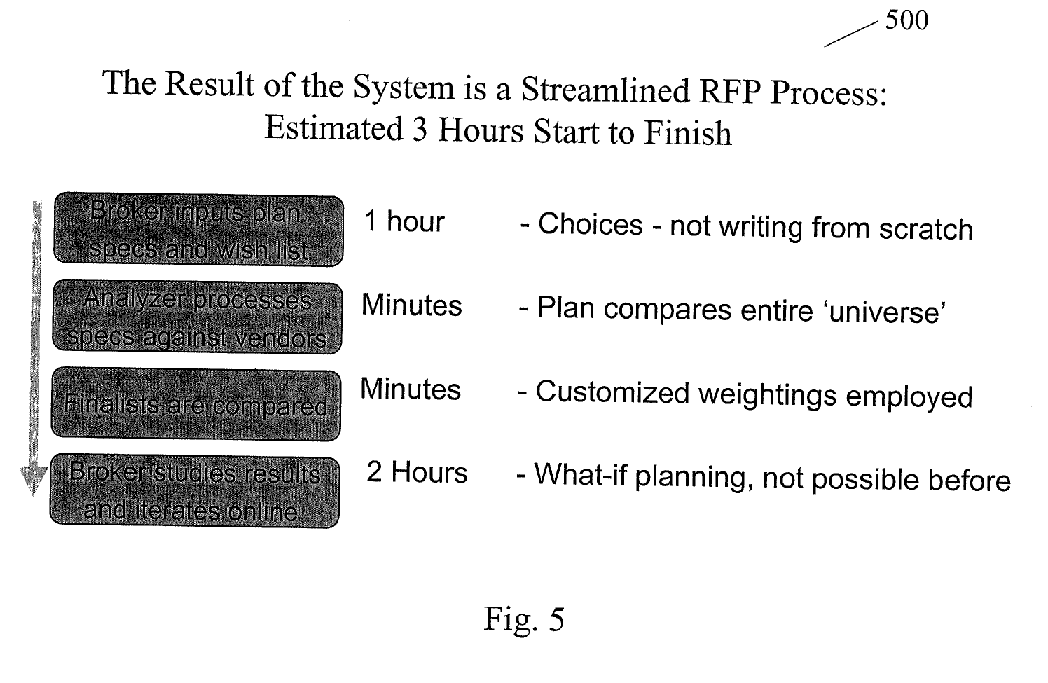

FIG. 5 illustrates the dramatic timesavings 500 using embodiments of the present invention. Embodiments of the present invention allow for an approximate 3 hour start to finish time in completing the RFP process. Plan sponsors are able to obtain a large number of preferred plan providers in a very short time. Brokers are able to efficiently provide plan sponsors with preferred defined contribution plans in response to plan sponsor preference values and characteristics. Plan providers are able to provide their defined contribution plans to a larger number of plan sponsors.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. For example, other embodiments include identifying other retirement plans or defined benefit plans. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for identifying a preferred defined contribution plan, comprising the steps of:
(a) transferring, from a broker processing device to a central processing device, a plurality of preference values associated with a respective plurality of performance categories;
(b) scoring, by the central processing device, a plurality of defined contribution plans, wherein a first defined contribution plan includes the plurality of performance categories and a respective plurality of performance category scores;
(c) ordering, by the central processing device, the plurality of defined contribution plans by the plurality of performance category scores;
(d) assigning, by the central processing device, a plurality of rank values to the respective plurality of defined contribution plans corresponding to the respective plurality of performance category scores; and,
(e) transferring, to the broker processing device from the central processing device, the preferred defined contribution plan in response to the plurality of preference values and the plurality of rank values.

2. The method of claim 1, wherein the defined contribution plan is a 401k plan.

3. The method of claim 1, wherein the performance categories are selected from a group consisting of a) communication between a vendor and participants, b) investment advice offered to participants, c) extent or ability to increase participation at a later date, d) flexibility in using multi-fund family offerings, e) performance of investments, f) ability to self-direct an accounts, g) cost to the plan sponsor, h) cost to the plan participants, i) amount of internal administration necessary or provided, j) accuracy and timeliness of the administration, k) existence of a local service contact and m) ability to handle trustee and 404(c) concerns.

4. The method of claim 1, wherein the transferring step (a) includes the step of using a graphic user interface to input preference values.

5. The method of claim 1, further comprises the step of a broker entering defined contribution plan characteristics.

6. The method of claim 5, wherein defined contribution plan characteristics are selected from group consisting of a) number of plan participants, b) plan size measured by assets, and c) cash flow.

7. The method of claim 1, wherein a first rank value, in the plurality of rank values, is a number between 1 and 5.

8. The method of claim 1, wherein the transferring step (a) includes a plan sponsor providing defined contribution plan characteristics to a broker.

9. The method of claim 1, wherein the transferring step (e) includes multiplying a first rank value in the plurality of rank values by a first preference value in the plurality of preference values to obtain a first plan category value.

10. The method of claim 9, wherein the transferring step (e) includes multiplying a second rank value in the plurality of rank values by a second preference value in the plurality of preference values to obtain a second plan category value; and wherein, the first plan category value and second plan category value are summed to select the preferred defined contribution plan.

11. The method of claim 1, wherein the assigning step includes assigning a rank value to a cost to company category in response to a Grid Matrix Analysis.

12. The method of claim 1, further comprising the step of:
(f) filtering, by the central processing device, the plurality of defined contribution plans in response to a defined contribution plan characteristic.

13. A system for identifying a preferred defined contribution plan, comprising:
(a) first processing device for providing a plurality of preference values; and,
(b) a second processing device, coupled to the first processing device, providing a preferred defined contribution plan in response to the plurality of preference values.

14. A computer for identifying a preferred defined contribution plan, comprising:
a storage device;
a processor, coupled to the storage device,
the storage device storing a program for controlling the processor; and,
the processor operative with the program to:
(a) receive a plurality of preference values;
(b) score a plurality of defined contribution plans, wherein a first defined contribution plan includes a plurality of performance categories and respective plurality of performance category scores;
(c) order the plurality of defined contribution plans by the plurality of performance categories;
(d) assign a plurality of rank values to the respective plurality of defined contribution plans corresponding to the respective plurality of performance category scores; and,
(g) select the preferred defined contribution plan in response to the plurality of preference values and the plurality of rank value.

15. The computer of claim 14, wherein the storage device stores a database containing the plurality of defined contribution plans and a respective plurality of performance category scores.

16. The computer of claim 14, wherein the storage device stores a plurality of broker identification numbers.

17. A method for identifying a preferred defined contribution plan, comprising the steps of:
(a) obtaining a plurality of preference values associated with respective performance categories;
(b) scoring a plurality of defined contribution plans, wherein a first defined contribution plan includes a plurality of performance categories and respective plurality of performance category scores;
(c) ordering the plurality of defined contribution plans by the plurality of performance category scores;
(h) assigning a plurality of rank values to the respective plurality of defined contribution plans corresponding to the respective plurality of performance category scores; and,
(i) selecting the preferred defined contribution plan in response to the plurality of preference values and the plurality of rank values.

18. The method of claim 17, wherein the selecting step includes multiplying a first rank value in the plurality of rank values by a first preference value in the plurality of preference values to obtain a first plan category value.

19. The method of claim 18, wherein the selecting step includes multiplying a second rank value in the plurality of rank values by a second preference value in the plurality of preference values to obtain a second plan category value, and wherein the first plan category value and second plan category value are summed to select the preferred defined contribution plan.

20. The method of claim 17, wherein the preferred defined contribution plan is a 401(k) plan.

21. The method of claim 17, wherein the obtaining step (a) includes the step of using a graphic user interface to input preference values.

22. The method of claim 17, further comprising the step of obtaining defined plan contribution characteristics.

23. The method of claim 22, wherein defined plan contribution characteristics are selected from a group consisting of a) number of plan participants, b) plan size measured by assets, and c) cash flow.

24. An article of manufacture, including a computer readable medium, comprising:
(a) a first software component for receiving a plurality of preference values associated with respective performance categories;
(b) a second software component for scoring a plurality of defined contribution plans, wherein a first defined contribution plan includes a plurality of performance catagories and respective plurality of performance category scores;
(c) a third software component for ordering the plurality of defined contribution plans by the respective plurality of performance category scores;
(d) a fourth software component for assigning a plurality of rank values to the respective plurality of defined contribution plans corresponding to the respective plurality of performance category scores; and,
(e) a fifth software component for providing a preferred defined contribution plan in response to the plurality of preference values and the plurality of rank values.

25. The article of manufacture of claim 24, further comprising a sixth software component for comparing the preferred defined contribution plan to another preferred contribution plan.
